(19) United States
(12) Patent Application Publication
(10) Pub. No.: US 2016/0196571 A1
(43) Pub. Date: Jul. 7, 2016

(54) POINT CONVERTING SYSTEM, POINT CONVERTING METHOD, AND APPARATUS APPLIED TO THE SAME

(71) Applicant: SK PLANET CO., LTD., Gyeonggi-do (KR)

(72) Inventors: Chang Hyun LEE, Seoul (KR); Chan Won PARK, Seoul (KR)

(73) Assignee: SK PLANET CO., LTD., Gyeonggi-do (KR)

(21) Appl. No.: 14/986,125

(22) Filed: Dec. 31, 2015

(30) Foreign Application Priority Data
Jan. 2, 2015 (KR) 10-2015-0000214

(51) Int. Cl. G06Q 30/02

(52) U.S. Cl. CPC G06Q 30/0226

(57) ABSTRACT

The present invention discloses a point converting system, a point converting method, and an apparatus applied to the same. That is, in relation to a point conversion among point companies providing respective point services, a point conversion ratio is determined based on points, which are converted, accumulated, and updated for the respective point companies, and the point conversion is performed according to the determined point conversion ratio, thereby avoiding an imbalance phenomenon in which a majority of points are unevenly converted for specific point companies.

### CROSS-REFERENCE TO RELATED APPLICATION

This application is based upon and claims the benefit of priority from Korean Patent Application No. 10-2015-0000214, filed on Jan. 2, 2015, the entire contents of which are incorporated herein by reference.

### BACKGROUND OF THE INVENTION

1. Field of the Invention

The present invention relates to a strategy which, in relation to a point conversion among point companies providing respective point services, determines a point conversion ratio based on points, which are converted, accumulated, and updated for the respective point companies, such that the point conversion is performed according to the determined point conversion ratio.

2. Description of the Related Art

There is provided a point-based service which provides points to customers in relation to electronic commerce, product purchases, and service uses, etc. in order to attract customers and promote products, etc. on-line and off-line.

This point-based service is gaining popularity among customers, since it compensates for a part of money of the customer spent for products and trades afterwards, and it also plays a role in boosting sales numbers of companies.

Recently, a point conversion service, which enables a point accumulated for a specific point company to be converted to other points for other point companies, is also becoming more and more popular.

However, it is a common situation that the points provided by respective point companies have different values and different benefits, and, therefore, an imbalance phenomenon in which a majority of points are unevenly converted for specific point companies can occur.

### SUMMARY OF THE INVENTION

The present invention has been envisaged by considering the situation mentioned above, and an objective to be accomplished by the present invention is to determine, in relation to a point conversion among point companies providing respective point services, a point conversion ratio based on points, which are converted, accumulated, and updated for the respective point companies, and to perform the point conversion according to the determined point conversion ratio, thereby avoiding an imbalance phenomenon in which a majority of points are unevenly converted for specific point companies.

A point converting apparatus according to a first aspect of the present invention for accomplishing the aforementioned objective comprises: a converting unit which converts points between a first point company and a second point company; an updating unit which accumulates the points which have been converted to each of the first point company and the second point company; and a determining unit which determines a point conversion ratio based on accumulated point information, which is related to points accumulated for each of the first point company and the second point company, such that point conversion is performed between the first point company and the second point company according to the determined point conversion ratio.

The point converting apparatus is characterized in that: at least one of overall accumulated point information, which is related to overall points which are accumulated for each of the first point company and the second point company, and individual accumulated point information, which is related to points accumulated and updated for a specific member or a specific group belonging to each of the first point company and the second point company, is included in the accumulated point information, and that the determining unit either determines the point conversion ratio for each of the first point company and the second point company based on the overall accumulated point information, or either determines the point conversion ratio for the specific member or the specific group belonging to each of the first point company and the second point company based on the individual accumulated point information.

The point converting apparatus is characterized in that the point converting apparatus further comprises an allocating unit which allocates point values for each of the first point company and the second point company, and that the allocating unit allocates the point values allocated for each of the first point company and the second point company according to the determined point conversion ratio.

The point converting apparatus is characterized in that at least one of the allocated point value and an accumulated point amount is included in the accumulated point information, and that the determining unit determines the point conversion ratio based on at least one of the accumulated point amount and an overall point value corresponding to the accumulated point amount.

The point converting apparatus is characterized in that the number of point accumulation is further included in the accumulated point information, and that the determining unit determines the point conversion ratio based on at least one of the number of point accumulation and the accumulated point amount with respect to the number of point accumulation.

The point converting apparatus is characterized in that at least one of an the number of accumulated point use and a point use amount is further included in the accumulated point information, and that the determining unit determines the point conversion ratio based on at least one of the number of accumulated point use, the point use amount, the point use amount with respect to the number of accumulated point use, and the number of accumulated point use with respect to the number of point accumulation.

A point converting method according to a second aspect of the present invention for accomplishing the aforementioned objective is characterized in comprising: a converting step in which a user terminal converts points between a first point company and a second point company by means of a point converting apparatus; an updating step in which the point converting apparatus accumulates the points which have been converted to each of the first point company and the second point company; and a determining step in which the point converting apparatus determines a point conversion ratio based on accumulated point information which is related to points accumulated for each of the first point company and the second point company, such that point conversion is performed between the first point company and the second point company according to the determined point conversion ratio.

An operating method of a point converting apparatus according to a third aspect of the present invention for accomplishing the aforementioned objective is characterized in comprising: a converting step in which points are converted between a first point company and a second point company; an updating step in which points, which have been converted to each of the first point company and the second point company, are accumulated; and a determining step in which a point conversion ratio is determined based on accumulated point information which is related to points accumulated for each of the first point company and the second point company, such that point conversion is performed between the first point company and the second point company according to the determined point conversion ratio.

The operating method of a point converting apparatus is characterized in that at least one of overall accumulated point information, which is related to overall points which are accumulated for each of the first point company and the second point company, and individual accumulated point information, which is related to points accumulated for a specific member or a specific group belonging to each of the first point company and the second point company, is included in the accumulated point information, and that, in the determining step, the point conversion ratio for each of the first point company and the second point company is determined based on the overall accumulated point information, or the point conversion ratio for the specific member or the specific group belonging to each of the first point company and the second point company is determined based on the individual accumulated point information.

The operating method of a point converting apparatus is characterized in that the method further comprises, before the converting step, an allocating step in which point values for each of the first point company and the second point company are allocated, and that, in the allocating step, the point values allocated for each of the first point company and the second point company are changed to be allocated according to the determined point conversion ratio.

The operating method of a point converting apparatus is characterized in that at least one of the allocated point value and an accumulated point amount is included in the accumulated point information, and that, in the determining step, the point conversion ratio is determined based on at least one of the accumulated point amount and an overall point value corresponding to the accumulated point amount.

The operating method of a point converting apparatus is characterized in that the number of point accumulation is further included in the accumulated point information, and that, in the determining step, the point conversion ratio is determined based on at least one of the number of point accumulation and the accumulated point amount with respect to the number of point accumulation.

The operating method of a point converting apparatus is characterized in that at least one of the number of accumulated point use and a point use amount is further included in the accumulated point information, and that, in the determining step, the point conversion ratio is based on based on at least one of the number of accumulated point use, the point use amount, the point use amount with respect to the number of accumulated point use, and the number of accumulated point use with respect to the number of point accumulation.

A point converting system according to a fourth aspect of the present invention for accomplishing the aforementioned objective is characterized in comprising: a user terminal which converts points between a first point company and a second point company; and a point converting device which accumulates the points which have been converted to each of the first point company and the second point company, and determines a point conversion ratio based on accumulated point information, which is related to points accumulated for each of the first point company and the second point company, such that point conversion is performed between the first point company and the second point company according to the determined point conversion ratio.

Therefore, by using the point converting system, the pointing converting method, and the apparatus applied to the same, in relation to a point conversion among point companies providing respective point services, a point conversion ratio is determined based on points, which are converted and accumulated for the respective point companies, and the point conversion is performed according to the determined point conversion ratio, thereby avoiding an imbalance phenomenon in which a majority of points are unevenly converted for specific point companies.

### BRIEF DESCRIPTION OF THE DRAWINGS

FIG. 1 is a schematical configuration diagram of a point converting system according to an embodiment of the present invention;

FIG. 2 is a diagram for describing a configuration of a point converting apparatus according to one embodiment of the present invention;

FIG. 3 is a schematical flowchart for illustrating an operation flow in the point converting system according to an embodiment of the present invention; and

FIG. 4 is a schematical flowchart for illustrating an operation flow of the point converting apparatus according to the first embodiment of the present invention.

### DETAILED DESCRIPTION OF THE INVENTION

Technical terms used herein are used merely for illustrating specific embodiments, and it is to be noted that they are not intended to limit technical spirit disclosed in this specification. Also, the technical terms used herein are to be construed by the meanings normally accepted by the person having ordinary skill in the relevant art, unless specifically defined by other meanings in this specification, and it is neither to be construed by excessively comprehensive meanings nor excessively narrow meanings. Also, when the technical terms used herein are determined to be wrong technical terms which fail to represent the technical spirit disclosed in this specification correctly, the terms are to be replaced by the technical terms which can be accurately understood by the person having ordinary skill in the art. Also, the general terms used in this specification are to be construed as defined in the dictionaries or according to context, and they are not to be construed in an excessively narrow meaning.

Also, the singular representation used in this specification includes plural representations unless it is clearly expressed in the context to the contrary. The term “include” or “is composed of” in this specification is not to be construed to necessarily include all components and all steps cited in this specification, and it should be construed to exclude some components or some steps or further include additional components and steps.

Also, the terms representing an ordinal number such as first, second, etc. used in this specification can be used to explain various components, however, the components are not to be limited by these terms. These terms are used only for discriminate one component from other components. For example, the first component can be entitled as a second component, and similarly, the second component can be entitled as the first component, without departing from the technical scope of the present invention.

In the following, embodiments disclosed in this specification are to be described in detail by referring to the appended figures, wherein the same reference numerals are given to the same or like components irrespective of the number of the figures, and duplicate description on them will be omitted.

Also, when it is determined that a detailed description on a relevant known art will obscure the subject matter disclosed in the specification while describing the technologies disclosed in this specification, the detailed description will be omitted. Also, it is to be noted that the appended figures are only for facilitating the technical spirit disclosed in this specification and the technical spirit are not to be construed to be limited by the appended figures.

Here, one embodiment of the present invention is described by referring to the appended figures.

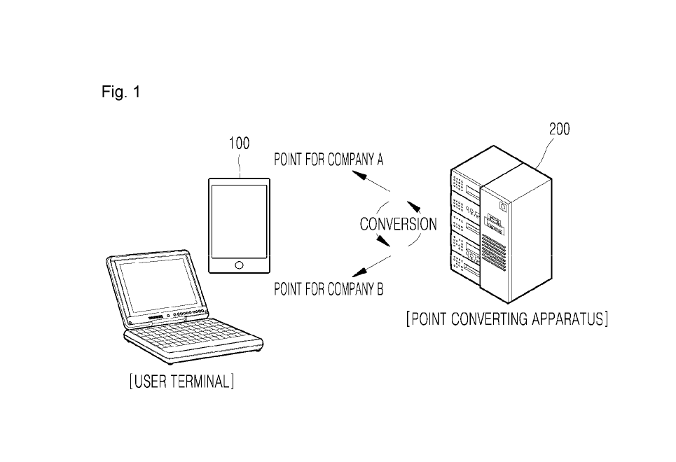

FIG. 1 is a diagram illustrating a point converting system according to an embodiment of the present invention.

As shown in FIG. 1, A point converting system according to an embodiment of the present invention has a configuration including a user terminal 100 which requests conversion of point, and a point converting apparatus which converts points among point companies according to the point conversion request received from the user terminal 100.

By referring to the user terminal 100, it represents a terminal which searches for a point accumulated for a user and requests the searched point to be converted to a point for other point companies.

For example, a smart phone, a tablet personal computer (PC), a desktop, a notebook, a personal digital assistant (PDA), and a point of sales (POS) device, etc. can be included in the user terminal 100; however, the user terminal is not limited to these examples, and all device, which is capable of searching for the point and requesting the point conversion, can be included in the user terminal.

By referring to the point converting apparatus 200, it represents a server which processes the point conversion request received from the user terminal 100, and, for example, this point converting apparatus 200 can be operated individually by respective point companies, or operated as a unified server which combines the servers of the respective point companies.

Meanwhile, according to an embodiment of the present invention, there is provided a point conversion service which enables a point, which is accumulated for a specific point company, to be converted to a point for other point companies.

As for the point conversion service, a dormant point, which is accumulated for a specific point company and not used for long, can be converted to be used for other point companies providing necessary benefits for the user, which is very advantageous on behalf of point utilization.

By the way, besides the aforementioned advantage on point utilization of the conventional point conversion service, it also has a drawback that a majority of points can be converted to some specific point companies, rather than being evenly distributed for all point companies.

That is, the point provided from respective point companies tend to have different point values and different benefits obtainable by the points, and, therefore, a majority of points can be converted to a specific point company which gives a greater point value or provides more advantageous benefits to the user, which leads to an imbalance phenomenon.

As a result, when the imbalance phenomenon in which a majority of points are concentrated to the specific point company occurs, competitiveness of the service provided by the rest point companies will be weak, and customers are less likely to be attracted by them, and, what makes it worse, the point service provided by the rest point companies can become useless.

Therefore, one embodiment of the present invention is intended to propose a solution for preventing an imbalance phenomenon in which a majority of points are unevenly converted to specific point companies, and the solution will be explained in detail in the following.

Meanwhile, for convenience of explanation, a first point company (company A) and a second point company (company B) will be referred to as representatives of a plurality of point companies for which the point conversion is performed.

The point converting apparatus 200 performs a function of allocating values to points.

More specifically, prior to processing the point conversion request from the user terminal 100, the point converting apparatus 200 comes to allocate point values to each of the points which are provided by the first point company and the second point company.

In the meantime, the point values allocated to the point of the first point company and that of the second point company can be defined to be the same as or different from each other, and the point values can be defined according to independent determinations of the respective point companies or based on an agreement among the point companies.

Here, by referring to the point value, it represents an objective value of a point, and the point value can be converted to a monetary value (for example, WON) of the point.

The point converting apparatus 200 performs a function of converting the points.

More specifically, after the point values are allocated and a point conversion request is received from the user terminal 100, the point converting apparatus 200 comes to convert the points between the first point company and the second point company.

In the meantime, the point converting apparatus 200 converts a point, which is accumulated for the first point company, to a point for the second point company, or converts a point, which is accumulated for the second point company, to a point for the first second point company, according to the point conversion request from the user terminal 100.

Also, the point converting apparatus 200 performs a function of accumulating and updating the converted point.

More specifically, when the point conversion is performed between the point for the first point company and the point for the second point company, the point converting apparatus 200 accumulates and updates the points which have been converted for each of the first point company and the second point company.

In the meantime, the point converting apparatus 200 manages the accumulated point amounts, which have been converted for each of the first point company and the second point company, as accumulated point information.

This accumulated point information can be classified into overall accumulated point information and individual accumulated point information.

As for the overall accumulated point information as above, it represents information which is related to overall points, which are accumulated and updated for each of the first point company and the second point company by all members belonging to each of the first and second point companies.

The individual accumulated point information represents information which is related to the points which are accumulated and updated for a specific member or a specific group belonging to each of the first point company and the second point company.

Here, a group is formed by classifying all members into members belonging to respective criteria based on a predetermined criterion defined by the respective point companies such as ages, regions, genders, etc.

Like this, the accumulated point information is classified into the overall accumulated point information and the individual accumulated point information in order to determine point conversion ratios for each of the first point company and the second point company by using the overall accumulated point information, and to determine the point conversion ratios for the specific member or the specific group which belong to the respective point companies by using the individual accumulated point information.

These overall accumulated point information and the individual accumulated point information are similar to each other except for a subject of the information; in addition to the aforementioned accumulated point amounts, information such as, for example, point values allocated for corresponding point companies, the number of point accumulation, the number of accumulated point use, point use amounts, and member store numbers of the corresponding point companies, etc. can be equally included in each of the overall accumulated point information and the individual accumulated point information.

As a result, since the information included in the overall accumulated point information and the individual accumulated point information are the same, a series of operations for determining the point conversion ratios for them are also the same except that the overall accumulated point information is to be used for determining overall point conversion ratios for the first point company and the second point company, and that the individual accumulated point information is to be used for determining the point conversion ratios for the specific member or the specific group belonging to the respective point companies.

Therefore, only the operation for determining overall point conversion ratios for the first point company and the second point company by using the overall accumulated point information (generally referred to as ‘accumulated point information’, hereinafter) will be explained for the convenience of explanation.

Also, the point converting apparatus 200 performs a function of determining the point conversion ratio.

More specifically, the point converting apparatus 200 determines the point conversion ratios based on the accumulated point information which is related to the points which are accumulated and updated for each of the first point company and the second point company.

In the meantime, the point converting apparatus 200 can determine the point conversion ratio for a point company, of the first point company and the second point company, having greater accumulated point amounts or a greater sum of point values, that is, monetary values of the accumulated points corresponding to the accumulated point amounts, to be higher than a current value, or to the contrary.

Also, the point converting apparatus 200 can determine the point conversion ratio for a point company, of the first point company and the second point company, having greater the number of point accumulation or greater accumulated point amounts with respect to the number of point accumulation, to be higher than a current value, or to the contrary.

Alternatively, the point converting apparatus 200 can determine the point conversion ratio for a point company, of the first point company and the second point company, having greater the number of accumulated point use, greater point use amounts, greater point use amounts with respect to the number of accumulated point use, or greater the number of accumulated point use with respect to the number of point accumulation, to be higher than a current value, or to the contrary.

Further, the point converting apparatus 200 can determine the point conversion ratio for a point company, of the first point company and the second point company, having a greater number of member stores, to be higher than a current value, or to the contrary.

Also, the point converting apparatus 200 performs a function of changing the point values to be allocated.

More specifically, when the point conversion ratio between the first point company is determined, the point converting apparatus 200 changes the point values which are allocated for each of the first point company and the second point company according to the determined point conversion ratio, such that after the changing time point, the point conversion will be performed between the first point company and the second point company according to the changed point conversion ratio.

In the meantime, when the point conversion ratio is determined to be higher than before for each of the first point company and the second point company, the point converting apparatus 200 can change the point values to be allocated to be greater than before, while when the point conversion ratio is determined to be lower than before, the point converting apparatus can change the point values to be allocated to be smaller than before.

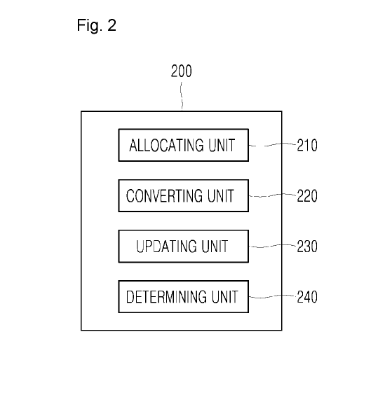

In the following, the configuration of the point converting apparatus 200 according to an embodiment of the present invention will be explained in detail by referring to FIG. 2.

That is, the point converting apparatus 200 according to an embodiment of the present invention can include an allocating unit 210 which allocates values to points, a converting unit 220 which converts the points, an updating unit 230 which accumulates and updates the converted point, and a determining unit 240 which determines the point conversion ratio.

Here, an overall configuration or a part of the point converting apparatus 200 including the allocating unit 210, the converting unit 220, the updating unit 230, and the determining unit 240 can be embodied as a hardware module or a software module, or can be embodied as a combination thereof.

The allocating unit 210 performs a function of allocating values to points.

More specifically, prior to processing the point conversion request from the user terminal 100, the allocating unit 210 comes to allocate point values to each of the points which are provided by the first point company and the second point company.

In the meantime, the allocating unit 210 allocates same or different point values for the points of the first point company and the second point company.

For example, when the allocated point values are the same, a point value of 1 won per 1 point can be allocated to both of the first point company and the second point company, while, when the allocated point values are different from each other, a point value of 3 won per 1 point can be allocated to the first point company and a point value of 1 won per 3 points can be allocated to the second point company; however, it will be readily understood that the allocated point values can be set to the contrary.

The converting unit 220 performs a function of converting points.

More specifically, after the point values are allocated by the allocating unit 210 and a point conversion request is received from the user terminal 100, the converting unit 220 comes to convert the points between the first point company and the second point company.

In the meantime, the converting unit 220 converts a point, which is accumulated for the first point company, to a point for the second point company, or converts a point, which is accumulated for the second point company, to a point for the first second point company, according to the point conversion request from the user terminal 100.

The updating unit 230 performs a function of accumulating and updating the converted point.

More specifically, when the point conversion is performed between the point for the first point company and the point for the second point company, the updating unit 230 accumulates and updates the points which have been converted for each of the first point company and the second point company.

In the meantime, the updating unit 230 comes to manage the accumulated point amounts, which have been converted for each of the first point company and the second point company, as the accumulated point information, and, in addition to the aforementioned accumulated point amounts, information such as, for example, point values allocated for corresponding point companies, the number of point accumulation, the number of accumulated point use, point use amounts, and member store numbers of the corresponding point companies, etc. can be equally included in the accumulated point information.

The determining unit 240 performs a function of determining the point conversion ratio.

More specifically, the determining unit 240 determines the point conversion ratios based on the accumulated point information which is related to the points which are accumulated and updated for each of the first point company and the second point company.

Here, it has been mentioned above that various information, in addition to the accumulated point amount, which is related to the accumulated point can be included in the accumulated point information which is referred to while determining the point conversion ratio.

Therefore, prior to determining the point conversion ratio, the determining unit 240 refers to some information among various information included in the accumulated point information and determines both whether to raise or lower the point conversion ratio and a change amount for the point conversion ratio, which can be realized by acknowledging a predefined point conversion strategy.

As a result, by acknowledging the predefined point conversion strategy, the determining unit 240 comes to refer to specific information included in the accumulated point information according to the acknowledged point conversion strategy to determine the point conversion ratio.

For example, the point values and the accumulated point amounts included in the accumulated point information can be used, and, in this case, the determining unit 240 can determine the point conversion ratio by using at least one of the accumulated point amounts and the point values corresponding to the accumulated point amounts.

In the meantime, the determining unit 240 comes to determine the point conversion ratio for a point company, of the first point company and the second point company, having greater accumulated point amounts or a greater sum of point values, that is, monetary values of the accumulated points corresponding to the accumulated point amounts, to be higher than a current value, or to the contrary.

Here, when it is said that a specific point company has greater accumulated point amounts or a greater sum of monetary values of the accumulated points, it means that the point company has greater point amounts converted to the corresponding point company, and, in this case, the point conversion ratio for the corresponding point company can be raised such that the point conversion for the corresponding point company is promoted, or the point conversion ratio can be lowered such that the point conversion for the corresponding point company is decreased.

As another example, the number of point accumulation included in the accumulated point information can be referred to, and, in this case, the determining unit 240 can determine the point conversion ratio by using one of the number of point accumulation and the accumulated point amounts with respect to the number of point accumulation.

In this case, the determining unit 240 comes to determine the point conversion ratio for a point company, of the first point company and the second point company, having greater the number of point accumulation or greater accumulated point amounts with respect to the number of point accumulation, to be higher than a current value, or to the contrary.

Here, when it is said that a specific point company has greater the number of point accumulation or a greater accumulated point amounts with respect to the number of point accumulation, it means as above that the point company has greater point amounts converted to the corresponding point company, and, in this case, the point conversion ratio for the corresponding point company can be raised such that the point conversion for the corresponding point company is promoted, or the point conversion ratio can be lowered such that the point conversion for the corresponding point company is decreased.

As another example, the number of accumulated point use and the point use amounts included in the accumulated point information can also be referred to, and, in this case, the determining unit 240 can determine the point conversion ratio by using at least one of the number of accumulated point use, the point use amounts, the point use amounts with respect to the number of accumulated point use, and the number of accumulated point use with respect to the number of point accumulation.

In this case, the determining unit 240 comes to determine the point conversion ratio for a point company, of the first point company and the second point company, having greater the number of accumulated point use, greater point use amounts, greater point use amounts with respect to the number of accumulated point use, or greater the number of accumulated point use with respect to the number of point accumulation, to be higher than a current value, or to the contrary.

Here, when it is said that a point company has greater the number of accumulated point use, greater point use amounts, greater point use amounts with respect to the number of accumulated point use, or greater the number of accumulated point use with respect to the number of point accumulation, it means that the point of the corresponding point company is preferred, and, in this case, the point conversion ratio for the corresponding point company can be raised such that the point conversion for the corresponding point company is promoted, or the point conversion ratio can be lowered such that the point conversion for the corresponding point company is decreased.

As an additional example, the member store number included in the accumulated point information can be referred to, and, in this case, the determining unit 240 can determine the point conversion ratio for a point company, of the first point company and the second point company, having a greater number of member stores, to be higher than a current value, or to the contrary.

Here, when it is said that a specific point company has a greater member store number, it means that the accumulated point for the point company is more likely to be used, and, in this case, the point conversion ratio for the corresponding point company can be raised such that the point conversion for the corresponding point company is promoted, or the point conversion ratio can be lowered such that the point conversion for the corresponding point company is decreased.

Also, the allocating unit 210 performs a function of changing the point values to be allocated.

More specifically, when the point conversion ratio between the first point company is determined, the allocating unit 210 changes the point values which are allocated for each of the first point company and the second point company according to the determined point conversion ratio, such that after the changing time point, the point conversion will be performed between the first point company and the second point company according to the changed point conversion ratio.

In the meantime, when the point conversion ratio is determined to be higher than before for each of the first point company and the second point company, the allocating unit 210 can change the point values to be allocated to be greater than before in order to promote the point conversion for the corresponding point company, while when the point conversion ratio is determined to be lower than before, the allocating unit can change the point values to be allocated to be smaller than before in order to decrease the point conversion for the corresponding point company.

Here, the change amount of the point values can be determined according to the change amount of the point conversion ratio, and it can be varied freely within an allocated change range such as 0.5 won to 1.5 won according to the change amount of the point conversion ratio.

As explained in the above, by using the point converting system according to an embodiment of the present invention, in relation to a point conversion among point companies providing respective point services, the point conversion ratio is determined based on points, which are converted, accumulated, and updated for the respective point companies, and the point conversion is performed according to the determined point conversion ratio, thereby avoiding an imbalance phenomenon in which a majority of points are unevenly converted for specific point companies.

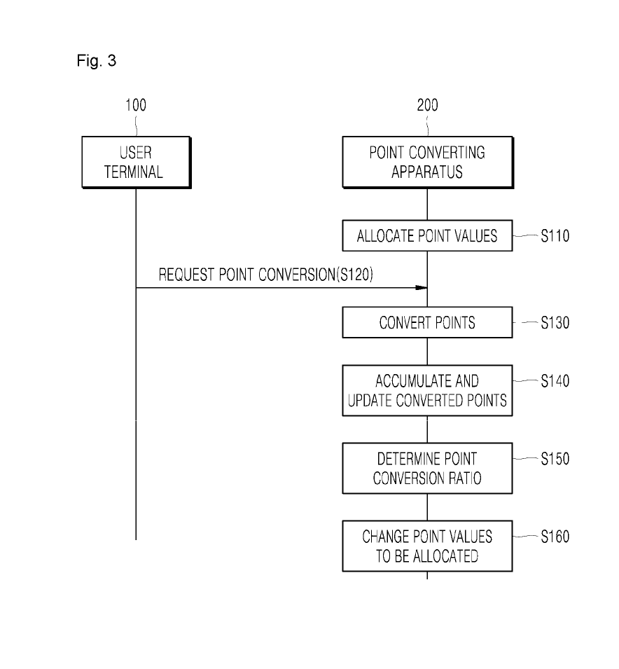

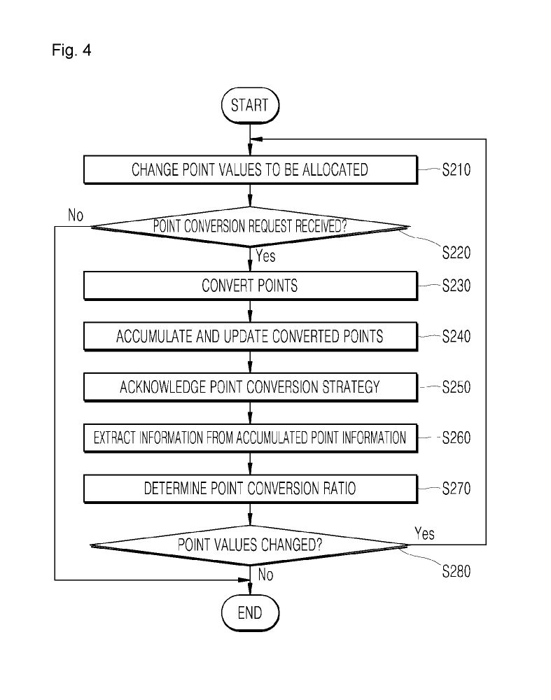

In the following, the point converting method according to an embodiment of the present invention will be explained by referring to FIGS. 3 and 4. Here, the configurations described in the FIG. 1 and FIG. 2 are referred to by using corresponding reference numbers for the convenience of description.

At first, the operation flow in the point converting system according to an embodiment of the present invention will be explained by referring to FIG. 3.

At first, prior to processing the point conversion request from the user terminal 100, the point converting apparatus 200 allocates point values to each of the points which are provided by the first point company and the second point company (S110).

In the meantime, the point converting apparatus 200 can allocate same or different point values for the points of the first point company and the second point company.

Then, after the point values are allocated and a point conversion request is received from the user terminal 100, the point converting apparatus 200 converts the points between the first point company and the second point company (S120-S130).

In the meantime, the point converting apparatus 200 converts a point, which is accumulated for the first point company, to a point for the second point company, or converts a point, which is accumulated for the second point company, to a point for the first second point company, according to the point conversion request from the user terminal 100.

Then, when the point conversion is performed between the point for the first point company and the point for the second point company, the point converting apparatus 200 accumulates and updates the points which have been converted for each of the first point company and the second point company (S140).

In the meantime, the point converting apparatus 200 comes to manage the accumulated point amounts, which have been converted for each of the first point company and the second point company, as the accumulated point information, and, in addition to the aforementioned accumulated point amounts, information such as, for example, point values allocated for corresponding point companies, the number of point accumulation, the number of accumulated point use, point use amounts, and member store numbers of the corresponding point companies, etc. can be equally included in the accumulated point information.

Furthermore, the point converting apparatus 200 determines the point conversion ratios based on the accumulated point information which is related to the points which are accumulated and updated for each of the first point company and the second point company (S150).

In the meantime, the point converting apparatus 200 can determine the point conversion ratio for a point company, of the first point company and the second point company, having greater accumulated point amounts or a greater sum of point values, that is, monetary values of the accumulated points corresponding to the accumulated point amounts, to be higher than a current value, or to the contrary.

Also, the point converting apparatus 200 can determine the point conversion ratio for a point company, of the first point company and the second point company, having greater the number of point accumulation or greater accumulated point amounts with respect to the number of point accumulation, to be higher than a current value, or to the contrary.

Alternatively, the point converting apparatus 200 can determine the point conversion ratio for a point company, of the first point company and the second point company, having greater the number of accumulated point use, greater point use amounts, greater point use amounts with respect to the number of accumulated point use, or greater the number of accumulated point use with respect to the number of point accumulation, to be higher than a current value, or to the contrary.

Further, the point converting apparatus 200 can determine the point conversion ratio for a point company, of the first point company and the second point company, having a greater number of member stores, to be higher than a current value, or to the contrary.

Then, when the point conversion ratio between the first point company is determined, the point converting apparatus 200 changes the point values which are allocated for each of the first point company and the second point company according to the determined point conversion ratio, such that after the change point, the point conversion will be performed between the first point company and the second point company according to the changed point conversion ratio (S160).

In the meantime, when the point conversion ratio is determined to be higher than before for each of the first point company and the second point company, the point converting apparatus 200 can change the point values to be allocated to be greater than before, while when the point conversion ratio is determined to be lower than before, the point converting apparatus can change the point values to be allocated to be smaller than before.

In the following, the operation of the point converting apparatus 200 according to an embodiment of the present invention will be explained in detail by referring to FIG. 4.

At first, prior to processing the point conversion request from the user terminal 100, the allocating unit 210 allocates point values to each of the points which are provided by the first point company and the second point company (S210).

In the meantime, the allocating unit 210 allocates same or different point values for the points of the first point company and the second point company.

For example, when the allocated point values are the same, a point value of 1 won per 1 point can be allocated to both of the first point company and the second point company, while, when the allocated point values are different from each other, a point value of 3 won per 1 point can be allocated to the first point company and a point value of 1 won per 3 points can be allocated to the second point company; however, it will be readily understood that the allocated point values can be set to the contrary.

Then, after the point values are allocated by the allocating unit 210 and a point conversion request is received from the user terminal 100, the converting unit 220 converts the points between the first point company and the second point company (S220-S230).

In the meantime, the converting unit 220 converts a point, which is accumulated for the first point company, to a point for the second point company, or converts a point, which is accumulated for the second point company, to a point for the first second point company, according to the point conversion request from the user terminal 100.

Then, when the point conversion is performed between the point for the first point company and the point for the second point company, the updating unit 230 accumulates and updates the points which have been converted for each of the first point company and the second point company (S240).

In the meantime, the updating unit 230 comes to manage the accumulated point amounts, which have been converted for each of the first point company and the second point company, as the accumulated point information, and, in addition to the aforementioned accumulated point amounts, information such as, for example, point values allocated for corresponding point companies, the number of point accumulation, the number of accumulated point use, point use amounts, and member store numbers of the corresponding point companies, etc. can be equally included in the accumulated point information.

Furthermore, the determining unit 240 determines the point conversion ratios based on the accumulated point information which is related to the points which are accumulated and updated for each of the first point company and the second point company (S250-S270).

As a result, by acknowledging the predefined point conversion strategy, the determining unit 240 comes to refer to specific information included in the accumulated point information according to the acknowledged point conversion strategy to determine the point conversion ratio.

For example, the point values and the accumulated point amounts included in the accumulated point information can be used, and, in this case, the determining unit 240 can determine the point conversion ratio by using at least one of the accumulated point amounts and the point values corresponding to the accumulated point amounts.

Here, the determining unit 240 comes to determine the point conversion ratio for a point company, of the first point company and the second point company, having greater accumulated point amounts or a greater sum of point values, that is, monetary values of the accumulated points corresponding to the accumulated point amounts, to be higher than a current value, or to the contrary.

As another example, the number of point accumulation included in the accumulated point information can be referred to, and, in this case, the determining unit 240 can determine the point conversion ratio by using one of the number of point accumulation and the accumulated point amounts with respect to the number of point accumulation.

Here, the determining unit 240 comes to determine the point conversion ratio for a point company, of the first point company and the second point company, having greater the number of point accumulation or greater accumulated point amounts with respect to the number of point accumulation, to be higher than a current value, or to the contrary.

As another example, the number of accumulated point use and the point use amounts included in the accumulated point information can also be referred to, and, in this case, the determining unit 240 can determine the point conversion ratio by using at least one of the number of accumulated point use, the point use amounts, the point use amounts with respect to the number of accumulated point use, and the number of accumulated point use with respect to the number of point accumulation.

Here, the determining unit 240 comes to determine the point conversion ratio for a point company, of the first point company and the second point company, having greater the number of accumulated point use, greater point use amounts, greater point use amounts with respect to the number of accumulated point use, or greater the number of accumulated point use with respect to the number of point accumulation, to be higher than a current value, or to the contrary.

As an additional example, the member store number included in the accumulated point information can be referred to, and, in this case, the determining unit 240 can determine the point conversion ratio for a point company, of the first point company and the second point company, having a greater number of member stores, to be higher than a current value, or to the contrary.

Then, when the point conversion ratio between the first point company is determined, the allocating unit 210 changes the point values which are allocated for each of the first point company and the second point company according to the determined point conversion ratio, such that after the changing time point, the point conversion will be performed between the first point company and the second point company according to the changed point conversion ratio (S280).

In the meantime, when the point conversion ratio is determined to be higher than before for each of the first point company and the second point company, the allocating unit 210 can change the point values to be allocated to be greater than before in order to promote the point conversion for the corresponding point company, while when the point conversion ratio is determined to be lower than before, the allocating unit can change the point values to be allocated to be smaller than before in order to decrease the point conversion for the corresponding point company.

As explained in the above, by using the point converting method according to an embodiment of the present invention, in relation to a point conversion among point companies providing respective point services, the point conversion ratio is determined based on points, which are converted, accumulated, and updated for the respective point companies, and the point conversion is performed according to the determined point conversion ratio, thereby avoiding an imbalance phenomenon in which a majority of points are unevenly converted for specific point companies.

Meanwhile, the realized articles of functional operations and subject matters described in this specification can be implemented using digital electronic circuits, or implemented as computer software, firmware, or hardware including the configuration disclosed in this specification and structural equivalents thereof, or as a combination be at least one of these implementations. The articles of realization of the subject matter described in this specification can be implemented as one or more computer program product, that is, one or more module related to computer program instructions which are encoded on a tangible program storage medium for controlling the operation of the process system or for being executed by the same.

The computer-readable medium can be a machine-readable storage device, a machine-readable storage board, a memory device, a composition of materials affecting machine-readable wave signals, and a combination of at least one of them.

The term such as “a system” or “a device” in this specification encompasses all tools, devices, and machines for processing data including, for example, a programmable processor, a computer, or a multi-processor. The process system can include a code for creating an execution atmosphere for the computer program, when requested by a code constituting a processor firmware, a protocol stack, a database management system, an operating system, or a combination of at least one of them, etc, in addition to a hardware.

The computer (also known as a program, a software, a software application, a script, or a code) can be created in all types of program languages including a compiled or interpreted language or a priori or procedural language, and can be arranged in all types including standalone programs, modules, subroutines, and other units proper to be used in a computing environment. The computer program does not necessarily correspond to a file of a file system. The program can be stored in a single file provided by the requested program, in multiple files which interact with each other (for example, files storing one or more module, low level programs or some of the code), or in a part of the file containing other programs or data (for example, one or more script stored in a markup language document). The computer program can be arranged to be positioned in one site or distributed over a plurality of sites, such that it can be executed on multiple computers interconnected via a communication network or on a single computer.

Meanwhile, the computer-readable medium which is proper for storing computer program instructions and data can include and all types of nonvolatile memories, media, and memory devices including a semiconductor memory device such as EPROM, EEPROM and flash memory device, a magnetic disk such as internal hard disk or removable disk, optical disk, a CD-ROM and a DVD-ROM disk. The processor and the memory can be supplemented by a special purpose logic circuit or integrated into the same.

The article of realization of the subject matter described in this specification can include a back-end component such as a data server, a middleware component such as an application server, or a front-end component such as a client computer having a web browser or a graphic user interface which enables a user to interact with the article of realization of the subject matter described in this specification, or can implement all combinations of these back-end, middleware, or front-end components in a computing system. The components of a system can be interconnected with each other by all types or media of digital data communication such as a communication network.

Although this specification includes details of various specific implementations, it is not to be understood as limiting for all inventions or scope to be claimed, and it should rather be understood as an explanation for the features which can be unique to specific implementations of the specific invention. Similarly, the specific features described in this specification in the context of separate implementations can be implemented to be combined in a single implementation. On the contrary, various features described in the context of the single implementation can also be implemented as discrete or proper low level combinations as well as in various implementations. Furthermore, although the features can be depicted as work in a specific combination and as claimed in the first place, one or more features from the claimed combination can be excluded from the combination in some cases, and the claimed combination can be changed to the low level combinations or subcombinations.

Also, although this specification depicts the operations in a specific order in the drawings, it is not to be understood that this specific sequence or order should be maintained or all the shown operations should be performed in order to obtain the preferred results In specific cases, multitasking and parallel processing can be preferable. Also, the division of various system components of the aforementioned embodiments are not to be construed as being required by all embodiments, and it is to be understood that the described program components and systems can generally be unified into a single software product or packaged in multiple software products.

Similarly, this specification is not intended to limit the present invention to specific terms provided. Therefore, although the present invention has been explained in detail by referring to the aforementioned examples, it is possible for the person having ordinary skill in the art to alter, change, or modify these examples without departing from the scope of the present invention. The scope of the present invention is expressed by the claims, not by the specification, and all changes and modified shapes derived from the meanings of the claims, scopes, and the equivalents thereof are construed to be included in the scope of the present invention.

What is claimed is:

1. A point converting apparatus characterized in comprising: a converting unit which converts points between a first point company and a second point company;
an updating unit which accumulates the points which have been converted to each of the first point company and the second point company; and
a determining unit which determines a point conversion ratio based on accumulated point information which is related to points accumulated for each of the first point company and the second point company, such that point conversion is performed between the first point company and the second point company according to the determined point conversion ratio.

2. The point converting apparatus according to claim 1, characterized in that:
the accumulated point information includes at least one of overall accumulated point information, which is related to overall points which are accumulated for each of the first point company and the second point company, and individual accumulated point information, which is related to points accumulated for a specific member or a specific group belonging to each of the first point company and the second point company, and
that the determining unit either determines the point conversion ratio for each of the first point company and the second point company based on the overall accumulated point information, or either determines the point conversion ratio for the specific member or the specific group belonging to each of the first point company and the second point company based on the individual accumulated point information.

3. The point converting apparatus according to claim 1 further comprises:
an allocating unit which allocates point values for each of the first point company and the second point company, and
the allocating unit allocates the point values for each of the first point company and the second point company according to the point conversion ratio.

4. The point converting apparatus according to claim 3, characterized in that the accumulated point information includes at least one of the allocated point value and an accumulated point amount, and
that the determining unit determines the point conversion ratio based on at least one of the accumulated point amount and an overall point value corresponding to the accumulated point amount.

5. The point converting apparatus according to claim 1, characterized in that the accumulated point information includes at least one of the accumulated point amount and the number of point accumulation, and
that the determining unit determines the point conversion ratio based on at least one of the number of point accumulation and the accumulated point amount with respect to the number of point accumulation.

6. The point converting apparatus according to claim 5, characterized in that the accumulated point information includes at least one of the number of accumulated point use and a point use amount, and
that the determining unit determines the point conversion ratio based on at least one of the number of accumulated point use, the point use amount, the point use amount with respect to the number of accumulated point use, and the number of accumulated point use with respect to the number of point accumulation.

7. A point converting method characterized in comprising:
a converting step in which a user terminal converts points between a first point company and a second point company by means of a point converting apparatus;
an updating step in which the point converting apparatus accumulates the points which have been converted to each of the first point company and the second point company; and
a determining step in which the point converting apparatus determines a point conversion ratio based on accumulated point information which is related to points accumulated for each of the first point company and the second point company, such that point conversion is performed between the first point company and the second point company according to the determined point conversion ratio.

8. An operating method of a point converting apparatus characterized in comprising:
a converting step in which points are converted between a first point company and a second point company;
an updating step in which points, which have been converted to each of the first point company and the second point company, are accumulated; and
a determining step in which a point conversion ratio is determined based on accumulated point information which is related to points accumulated for each of the first point company and the second point company, such that point conversion is performed between the first point company and the second point company according to the determined point conversion ratio.

9. The operating method of a point converting apparatus according to claim 8, characterized in that the accumulated point information includes at least one of overall accumulated point information, which is related to overall points which are accumulated for each of the first point company and the second point company, and individual accumulated point information, which is related to points accumulated for a specific member or a specific group belonging to each of the first point company and the second point company, and
that, in the determining step, the point conversion ratio for each of the first point company and the second point company is determined based on the overall accumulated point information, or the point conversion ratio for the specific member or the specific group belonging to each of the first point company and the second point company is determined based on the individual accumulated point information.

10. The operating method of a point converting apparatus according to claim 8, further comprises, before the converting step, an allocating step in which point values for each of the first point company and the second point company are allocated, and
that, in the allocating step, the point values allocated for each of the first point company and the second point company are changed to be allocated according to the determined point conversion ratio.

11. The operating method of a point converting apparatus according to claim 10, characterized in that the accumulated point information includes at least one of the allocated point value and an accumulated point amount, and
that, in the determining step, the point conversion ratio is determined based on at least one of the accumulated point amount and an overall point value corresponding to the accumulated point amount.

12. The operating method of a point converting apparatus according to claim 8, characterized in that the accumulated point information further includes at least one of the accumulated point amount and the number of point accumulation, and
that, in the determining step, the point conversion ratio is determined based on at least one of the number of point accumulation and the accumulated point amount with respect to the number of point accumulation.

13. The operating method of a point converting apparatus according to claim 12, characterized in that the accumulated point information further includes at least one of the number of accumulated point use and a point use amount, and
that, in the determining step, the point conversion ratio is based on at least one of the number of accumulated point use, the point use amount, the point use amount with respect to the number of accumulated point use, and the number of accumulated point use with respect to the number of point accumulation.
